(19) United States
(12) Patent Application Publication
(10) Pub. No.: US 2006/0182662 A1
(43) Pub. Date: Aug. 17, 2006

(54) Fused silica micropipette and method of manufacture

(76) Inventor: April Dean, Kentfield, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 11/058,114

(22) Filed: Feb. 15, 2005

(51) Int. Cl. B01L 3/02

(52) U.S. Cl. 422/100

(57) ABSTRACT

A fused silica micropipette having a complex shape, and method of manufacture, are disclosed. The fused silica micropipette may be used for microinjection applications, such as assisted conception, wherein the micropipette penetrates a cell membrane prior to injection. A high temperature, laser powered microforge capable of working with fused silica to make the complex structures of the micropipette of the present invention is also disclosed.

### FIELD OF THE INVENTION

The present invention is related to pipettes, and is particularly directed to a fused silica micropipette for cellular applications.

### BACKGROUND OF THE INVENTION

Very fine diameter pipettes, or micropipettes, are used in various scientific applications for research or clinical procedures at the cellular level. As used herein, the term “micropipette” is used to mean a pipette having a tip diameter of less than about 150 microns. Micropipettes may be used, for example, to penetrate the wall or membrane of a living cell in order to inject something into the cell, or to act as a recording electrode, without damaging the cell. Likewise, a micropipette may be used to apply suction to hold a cell for observation or further manipulation during the course of an experiment or procedure.

Typically, micropipettes are made from glass capillaries that are heated and then stretched to reduce the diameter of a portion of the tubing to a suitable dimension. Exemplary methods and apparatus for making fine diameter pipettes with high precision are disclosed in U.S. Pat. Nos. 4,600,424 and 5,181,948. The foregoing patents, however, are limited to methods and apparatus for making micropipettes which are linear or straight, i.e., wherein the lumen defines a single axis.

There is a demand for micropipettes having more complex structures that are tailored to the specific applications for which they are used. Such complex structures include micropipettes having tips with specific beveled profiles, having tips with spikes or other added surface features, or having one or more bends near the tip. Techniques for forming glass micropipettes having complex structures using a microforge are described in Chapter 10 “Microtool Manufacture” of the text “Micromanipulation in Assisted Conception” (Flaming, S. D. and King, R. S., Cambridge University Press, 2003). As noted in this chapter, glass micropipettes are commercially available in a variety of different configurations for specific applications.

One of the most important clinical uses of micropipettes is in the field of assisted conception. In one well-known procedure, a first micropipette is used to aspirate and inject sperm cells directly into an oocyte which is held in position by a second micropipette. Each of the micropipettes used in this procedure is designed with its specific function in mind. Thus, the micropipette used for injection, sometimes referred to as a microinjection pipette, has a different structure than the holding micropipette. Another important application is in the field of embryonic stem cell research.

Heretofore, available microforges capable of making micropipettes with complex structures have been limited to working with glass. Specifically, previously available microforges have been incapable of working with fused silica (quartz), because of their inability to provide the much higher temperature needed to soften fused silica so that it can be worked. As a result, micropipettes having complex shapes, such as bends, spikes, etc., have heretofore been made of glass, and such glass micropipettes have been considered adequate for use in assisted conception and other cellular microinjection applications. Thus, there are no known fused silica micropipettes with complex structure in the prior art, nor is there any reason articulated in the prior art to make one.

### BRIEF DESCRIPTION OF THE DRAWING

FIG. 1 is a side view of an exemplary embodiment of the fused silica micropipette of the present invention.

FIG. 2 is a partial view of the tip of an exemplary micropipette of the present invention.

FIG. 3 is a schematic diagram of a microforge for making the micropipettes of the present invention.

### DETAILED DESCRIPTION OF PREFERRED EMBODIMENTS

Quartz, or fused silica, is known to have properties which are useful in certain specific micropipette applications. These properties include strength, low electrical noise, good optical clarity and chemical purity. Thus, for example, the low noise properties of quartz is important for micropipettes used as intracellular recording electrodes. However, fused silica is substantially more difficult to work due to its relatively very high melting point. Thus, heretofore, fused silica micropipettes have generally not been employed unless a specific property of the material was required for the specific application. None of the known beneficial material properties of fused silica has previously been considered important for micropipettes used for microinjection and, therefore, to date there has been no impetus to use fused silica micropipettes in assisted conception or other microinjection procedures.

Heretofore, microforges capable of heating fused silica to a working temperature have not been available and, therefore, it has been impossible to fashion micropipettes having complex structures out of fused silica. This has not been a perceived problem because glass micropipettes have been considered adequate for those applications requiring complex structures. However, the present inventor has discovered, after developing a high temperature microforge capable of working with fused silica, that fused silica micropipettes have unexpected advantages when used in certain microinjection applications such as assisted conception.

While applicant has discovered that the fused silica micropipettes of the present invention produce superior results in assisted conception, the reasons why they are superior is not fully understood. The superior results appear to be unrelated to any of the known reasons for using fused silica, i.e., there is no apparent relation between the superior results discovered by the applicant and the greater strength, lower noise, optical properties, etc., of fused silica. Specifically, the applicant has discovered that the fused silica micropipettes of the present invention more readily penetrate through cell membranes and are, therefore, easier for clinicians and researchers to work with than glass pipettes for conducting procedures such as microinjection. Applicant hypothesizes that the greater apparent ease with which fused silica penetrates into cellular tissue is related to the surface chemistry of the quartz which makes the surface less “sticky” relative to the membrane materials. It is believed that this could be related to the fact that fused silica has fewer hydroxyl (OH—) groups on its surface than glass.

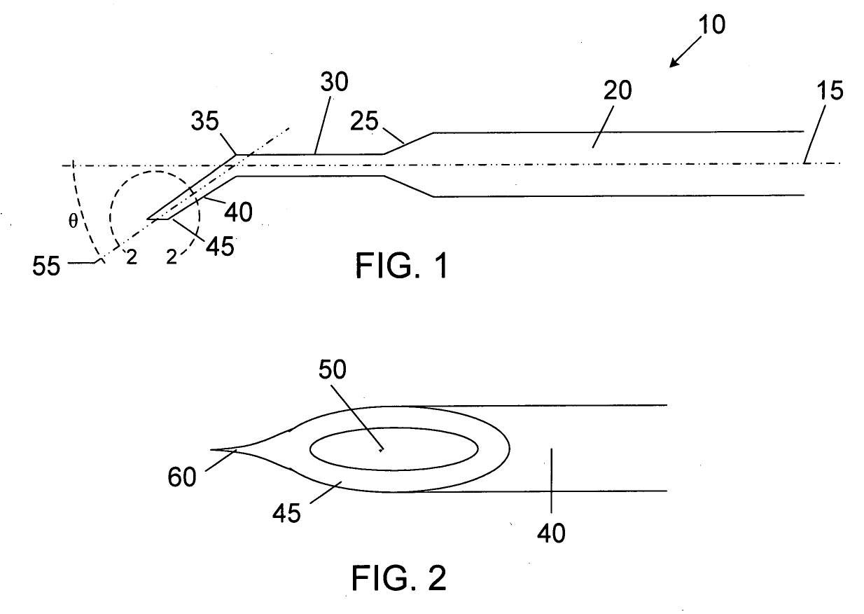

FIG. 1 depicts a fused silica micropipette 10 in accordance with a preferred embodiment of the present invention, which is useful in connection with clinical assisted conception procedures. The illustration of FIG. 1 is not drawn to scale. Fused silica micropipette 10 comprises a shaft 20 which constitutes the major portion of the micropipette. At one end of shaft 20 the micropipette reduces diameter at a shoulder region 25 which leads to a shank 30 of reduced diameter. Shank 30 may either be substantially constant in diameter or slightly tapered. Shank 30 has a bend 35 formed therein, as described below, defining a tip portion 40 of micropipette 10. As depicted in FIG. 2, tip portion 40 has an end 45 having an opening 50 therein and a spike 60. End 45 is preferably beveled. Various types of bevels may be used, depending on the application and the preferences of the user. Opening 50 communicates with the capillary lumen, permitting micropipette 10 to aspirate or inject materials, such as sperm cells, embryonic stem cells, etc. In other embodiments, such an opening may be used to apply slight suction to hold a cell in position. However, a micropipette used for holding a cell usually does not have a spike. Spike 60 enhances the ability of micropipette 10 to penetrate a cell wall membrane.

In a preferred embodiment, shaft 20, shoulder 35 and the portion of shank 30 between the shoulder and bend 35 are all coaxial, define a single axis 15. Likewise, tip 40 defines an axis 55 which intersects axis 15 at bend 35. According to one embodiment of the present invention, the angle θ between axes 15 and 55 is preferably in the range of about 30° to about 60°. The cellular level applications which use micropipettes generally require the use of microscopes and micromanipulators to observe and conduct the procedures. Frequently more than one tool is in use at a time within the relatively small area in the microscope's field of view. Therefore, other bends may be made in micropipette 10, as required, in order to facilitate use of the tool in a crowded space. Thus, the angle θ may simply be viewed as the angle of bend 35, without regard to the axial alignment of the remaining structure of micropipette 10.

A high temperature micropipette puller capable of processing fused silica, such as the P-2000 laser-based system available from Sutter Instrument Company of Novato, Calif., may be used in a traditional way to stretch a fused silica capillary to reduce its diameter to a desired dimension. Capillaries having a starting diameter of 1 mm or more may be used. As is known, the stretched capillary is scored and broken to form a tip which is then beveled using a suitable grinding wheel or other abrasive surface. After this procedure, shank 30 preferably has a diameter less than about 150 μm. The desired tip diameter depends on application for which the micropipette is to be used. In one preferred embodiment the tip diameter is less than about 10 microns. The pulling and subsequent processing produces a micropipette (not shown) having shaft 20, shoulder 25, shank 30, beveled tip 45 and opening 50. Further working of the tool requires the use of a microforge.

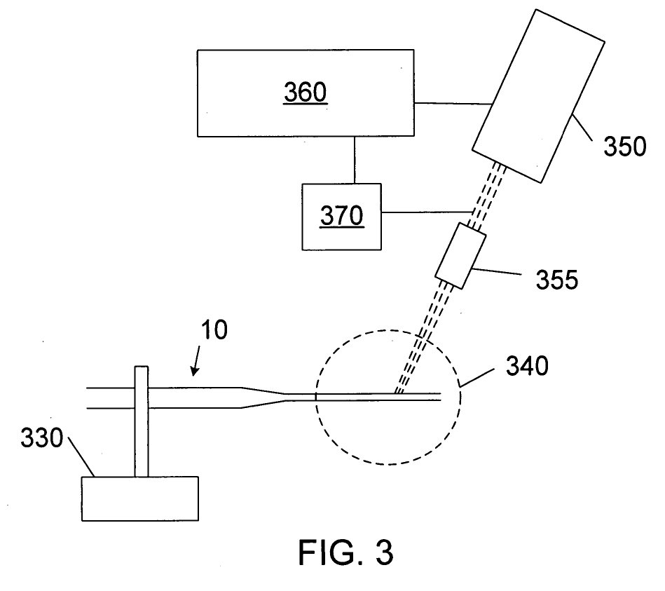

FIG. 3 is a schematic diagram of a novel high temperature microforge, developed by the present inventor, for making the fused silica micropipettes of the present invention. Micropipette 10 is held in the microforge by micromanipulator 330 or other suitable micropositioning device. The tip of the micropipette is positioned in the field of view of microscope 340, where it is heated using a beam from laser 350, under the control of laser control electronics 360. In a preferred embodiment, laser 350 is a CO₂ laser. Adjustable focusing optics 355 concentrate the laser beam to a desired spot size within the field of view of microscope 340. The position at which the focused laser beam strikes the micropipette may be adjusted by micromanipulator 330. Beam detector 370 provides feedback to laser control electronics concerning the beam intensity. While beam detector 370 is depicted in FIG. 3 between laser 350 and focusing optics 355, it could, alternatively, be positioned after focusing optics 355. One or more of these devices, e.g., the laser controller, the micromanipulator, the focusing optics, etc., may be under the programmable control of a computing device (not shown) such as a personal computer.

In order to create a bend in the micropipette, such as bend 35, the laser beam is focused onto the shank of the micropipette at the point where the bend is to be made. The laser power output and duration of beam application can be adjusted to provide the correct amount of heat necessary to create the bend. The temperature differential arising from the fact that the laser beam is incident only on one side of the micropipette is usually sufficient to cause spontaneous bending. If desired, however, a mechanical force can be used after the tool has been heated to assist the bending operation. While one bend 35 is shown in the preferred embodiment of FIG. 1, multiple bends may be created in a single micropipette in the same manner.

Spike 60 may be formed on the tip of the micropipette by using the laser to heat a small ball of fused silica until it is molten, then moving the tip of the micropipette into contact with the molten ball using micromanipulator 330. Alternatively, the molten ball may be moved into contact with the tip of the micropipette. After contact is made, the tip and the ball are quickly separated using the micromanipulator, resulting in the formation of spike 60. By adjusting the power output of the laser, the viscosity of the molten ball can be varied, thereby providing the ability to control the length of spike 60. Micromanipulator 330 may be programmed to withdraw a set distance with a desired velocity profile in order to provide reproducible results.

The embodiments described above are illustrative of the present invention and are not intended to limit the scope of the invention to the particular embodiments described. Accordingly, while one or more embodiments of the invention have been illustrated and described, it will be appreciated that various changes can be made therein without departing from the spirit or essential characteristics thereof. For example, while the construction of the preferred embodiment of the present invention has been described in connection with a capillary, those skilled in the art will appreciate that a solid fused silica rod my be used for tools not requiring a lumen. Accordingly, the disclosures and descriptions herein are intended to be illustrative, but not limiting, of the scope of the invention, which is set forth in the following claims.

I claim:

1. A micropipette, comprising,
a shaft,
a reduced diameter shank extending from an end of said shaft, said shank comprising a tip portion having an opening at the distal end thereof which communicates with said shaft,
wherein said shank is bent, and
wherein said micropipette is made of fused silica.

2. The micropipette of claim 1 further comprising a spike formed on said tip.

3. The micropipette of claim 1 wherein said angle is in the range of 30 to 60 degrees.

4. The micropipette of claim 1 wherein said tip is beveled.

5. The micropipette of claim 1 wherein said shaft has a diameter less than about 1 mm and said tip portion has a diameter less than about 10 microns.

6. A method of assisted conception comprising using the micropipette of claim 1 to inject sperm cells into an oocyte.

7. A method of making a fused silica micropipette, comprising the steps of:
heating a portion of a fused silica capillary using a laser, said fused silica capillary having an outside diameter of less than about 1.5 mm,
using a capillary puller to stretch the heated portion of said fused silica capillary to form a reduced diameter shank, whereby a shoulder is created between the unstretched portion of said capillary and said shank
breaking said shank to form a tip distal from said shoulder, and
using a laser-powered microforge to create a bend in said shank at an intermediate position between said shoulder and said tip.

8. The method of claim 7 wherein said tip has a diameter of about 10 microns or less.

9. The method of claim 7 further comprising the step of using said laser-powered microforge to form a spike on said tip.

10. The method of claim 7 further comprising the step of beveling said tip.

11. A microforge for making tools from fused silica, comprising:
a laser capable of melting fused silica,
a laser controller for controlling the output of said laser,
laser optics for focusing a light beam from said laser at a desired location within the field of view of a microscope, and
micropositioning apparatus for moving a tool undergoing processing within the field of view of a microscope.

12. The microforge of claim 11 further comprising a beam detector for providing feedback to said laser controller about the properties the light beam emitted from said laser.

13. A method of assisted conception, comprising the steps of,
aspirating sperm cells using a fused silica micropipette, said fused silica micropipette having a spike on the tip thereof,
thereafter, inserting the tip of said fused silica micropipette into an oocyte and injecting said aspirated sperm cells into said oocyte.
